(19) United States
(12) Patent Application Publication
(10) Pub. No.: US 2013/0179519 A1
(43) Pub. Date: Jul. 11, 2013

(54) SYSTEM AND METHOD FOR COLLABORATION, MESSAGING AND INFORMATION EXCHANGE BETWEEN ENGINEERING TOOLS

(71) Applicant: ABB Technology AG, Zurich (CH)

(72) Inventors: Rainer DRATH, Weinheim (DE); Volker MIEGEL, Julich (DE)

(73) Assignee: ABB Technology AG, Zurich (CH)

(21) Appl. No.: 13/779,794

(22) Filed: Feb. 28, 2013

Related U.S. Application Data
(63) Continuation of application No. PCT/EP2010/005341, filed on Aug. 31, 2010.

(51) Int. Cl. H04L 12/58

(52) U.S. Cl. CPC H04L 51/04
USPC 709/206

(57) ABSTRACT

A system and method are provided for the collaboration between engineering tools and engineers. A data processing unit is combined with or includes a source engineering tool having a source engineering data storage. The data processing unit exchanges data with at least one target data processing unit associated with at least one target engineering tool having its own engineering data storage. The collaboration system and method provides engineers of the source or target engineering tools to generate collaboration requests or collaboration responses which are automatically assigned to the corresponding engineering data object, and the owner and receivers of regarding engineering data objects are automatically notified about corresponding collaboration requests or responses across engineering tools and data processing units.

### RELATED APPLICATIONS

This application claims priority as a continuation application under 35 U.S.C. §120 to PCT/EP2010/005341 filed as an International Application on Aug. 31, 2010 designating the U.S., the entire content of which is hereby incorporated by reference in its entirety

### FIELD

The present disclosure relates to a system and method for improved collaboration, messaging and information exchange between engineering tools and engineers.

### BACKGROUND INFORMATION

The engineering of plants in manufacturing, power, chemical and/or process industries is characterized by a strong phase and tool separation. The separation has been formed in history because of the complexity of the plants and the need for work sharing. The separation is visible in different industries, education and institutes, and in a strong separation of engineering tools. In each engineering phase, different engineers with different professions perform engineering tasks supported by multiple engineering tools. Different aspects of engineering data are created, hosted and owned by these tools. Additionally, the same engineering information is shared among them.

Due to the growing complexity and amount of engineering data, modern engineering tools provide object oriented techniques for efficient data management. Following this concept, real objects are modeled by data objects and corresponding information belonging to that object. For instance, a device “pump P1” is modeled by a data object “P1” of type “pump”. Hence, the modeling of a factory cell, a production line, a unit or a plant requires a logical decomposition and identification of its elements and its topology with their individual objects representing the elements of the cell, line, unit or plant, for example, a “tank”, “pump”, “conveyor”, “PLC” or “robot”. The individual data objects are characterized by attributes, interfaces, behavior, relations, etc. Individual and concrete data objects are called “instances”, whereas abstract data objects are, for example, called “classes”, “object types”, “base objects” etc.

If multiple engineering tools are used in order to engineer different aspects of the same object, they need to exchange and share engineering data objects. This requires a data exchange procedure.

The exchange of engineering data between engineering tools which is fundamental for the functionality of such a system is currently managed by different approaches.

According to a first approach, the related engineering tools are connected to the same common data model stored in common data storage. Here the data are designed for cooperation and—in the ideal case—all engineering data are being stored only one time. This avoids redundancies and additional consistency checks. Any change of engineering data performed in one tool is immediately reflected by the other connected tools. The common database represents the current status of the project data.

This approach leads to a set of dependent engineering tools which are designed for cooperation. Accordingly, they are linked together and act as a tool suite. They are characterized by a deep integration level in that they belong together and have at least implicit knowledge about each other. As long as all related tools share the same data model and the same data base, no separate data exchange between them is necessary.

In a second approach, any engineering tool has its own private data model and data storage (see FIG. 1) and does not share data in a common data model and database. Such tools are not explicitly designed to cooperate with each other and need to exchange their data in separate processes. Any change of data in one tool is not automatically reflected by the other tools since changes need to be explicitly transferred to the other tools by means of electronic data containers like files. Accordingly, such data exchange procedure requires approval steps which perform consistency checks.

This second approach keeps the independency of the corresponding engineering tools. The integration between those tools can be achieved by means of a loose coupling with a separate data exchange process. In this case, the engineering tools need to provide data exporters and importers and furthermore need to exchange electronic data containers.

According to a third approach, the engineering tools have their own data storage for their private data, but they additionally share a common database for the common data. This represents a combination of the first and second approaches.

Since most engineering tools in industry are independent from each other, the second approach is the most common. Only a few software vendors provide tools corresponding to the first approach or the third approach.

It is known for the data exchange between independent engineering tools (see FIG. 1) to be processed manually, semi-automatically or automatically. Established techniques are exchanging specific formats of files or providing dedicated software interfaces, for example, web services. A dedicated data exchange system which is separate from the engineering tools has been described in WO2011/066846.

Besides the data exchange between the engineering tools, there is a need for collaboration between the corresponding engineers—they need to share information, goals and background information. Engineers need to exchange information with each other, especially if they work on different tools and/or locations. Examples of subjects of the information exchange are data objects and their characteristics as to, for example, their internal architecture, their relations to each other, related documents about them and ownership properties.

The term “collaboration” includes “collaboration requests” on one hand, for example, questions, remarks, hints, requests or complaints. On the other hand, the term “collaboration” includes “collaboration responses” which provide the counterpart to the corresponding “collaboration requests”. These may be texts, illustrated explanations, documents, diagrams, references or guidelines with the goal to provide hints and answers.

A known file based data exchange procedure is illustrated in FIG. 2 where tool A exports data from its private database A into a data exchange file. The data object “PLC02” (1) representing a certain PLC (Programmable Logic Controller) in the plant is hence exported and represented by “PLC02” (2) in the data exchange file. After importing it into Tool B, it is represented by the engineering object “PLC02” (3) in the database B of Tool B.

A known industrial approach regarding collaboration is a customer feedback tracking system. This allows participants to enter feedback information and to track the change status of the information. However, this is a separate and additional tool which is executed independently from the original engineering tools. Hence, the subjects of collaboration and the collaboration content are not bound together. This approach is commonly used in software development, but is not supported by industrial engineering tools in the manufacturing or process industry.

Another known collaboration approach in the office world is provided by dedicated collaboration software which allows multiple people to type text in the same document at the same time. This approach is not currently supported by industrial engineering tools in industry.

Another known collaboration concept in the consumer market is social networking, known by techniques like blogs, for example. Such techniques allow the easy-to-use sharing of messages, comments, videos, and photos to a broad audience. Further it allows short term feedback from the receivers. These concepts focus on extended and global communication between human beings and are well accepted by consumers. Though first approaches are made in industrial marketing, these techniques are not currently implemented in industrial engineering tools in the industry.

Corresponding to known engineering tools, there is no systematic and structured collaboration system or method that supports collaboration functionality between different engineers and their individual engineering tools. Known engineering tools do not provide means for a dedicated handling of collaboration requests or responses between engineers.

Instead, the collaboration of engineers is done individually by human interactions where the quality and efficiency strictly depends on the engineer's ability to communicate. Collaboration activities can include phone calls, conversations, meetings, discussions, emails or written documents which are exchanged between the engineers.

Especially in distributed engineering environments with engineers spread in different departments, sub-contractors or locations, using different engineering tools, the need for collaboration becomes more and more relevant. The drawbacks of the mentioned human collaboration techniques are:
Personal talks are efficient, but they belong only to the involved persons and are hardly documented and inaccessible to others.
Emails are efficient, but only accessible by the involved persons.
Exchanged information is not explicitly associated with the corresponding data objects in a structured and transparent way.
Written documents include bulk information and generally do not support questions, feedback or corrections without contacting the author who revises and reprints or redistributes the written document.
The status of information being exchanged with the above mentioned techniques cannot be tracked efficiently in this way. All changes, acknowledgments, rejections or even the type of information remain undocumented and untraceable.
There is no systematic way for the identification of a responsible person who is authorized and able to participate or accomplish the collaboration role.

Hence, there is no structured way established or known within known engineering tools in order to systematically identify the owner or creator of engineering data. Finally, questions, hints, complains, inconsistencies, warnings or their status cannot be shared or tracked systematically.

### SUMMARY

An exemplary embodiment of the present disclosure provides a system for collaboration between engineering tools and engineers. The exemplary system includes a source data processing unit associated with a source engineering tool having a source engineering data storage that stores an engineering data object about the source engineering tool. The exemplary system also includes at least one target data processing unit respectively associated with at least one target engineering tool having a source engineering data storage that stores an engineering data object about the at least one target engineering tool, respectively. The source data processing unit is configured to exchange data with the at least one target data processing unit to enable engineers of the source or target engineering tools to create collaboration requests or collaboration responses which are automatically assigned to the corresponding engineering data object of the source or target engineering tools, and to automatically notify an owner and receiver of respective engineering data objects of corresponding collaboration requests or responses across the source engineering tool and the at least one target engineering tool and corresponding source and target data processing units, respectively.

An exemplary embodiment of the present disclosure provides a method for collaboration between engineering tools and engineers. The exemplary method includes providing at least one first engineer with a source data processing unit associated with a source engineering tool having a source engineering data storage that stores an engineering data object about the source engineering tool. The exemplary method also includes providing at least one second engineer with at least one target data processing unit respectively associated with at least one target engineering tool having a source engineering data storage that stores an engineering data object about the at least one target engineering tool, respectively. In addition, the exemplary method includes generating, in at least one of the source data processing unit and the at least one target data processing unit, at least one of collaboration requests and responses to the collaboration requests for at least one of the source engineering tool and the at least one target engineering tool. Furthermore, the exemplary method includes automatically assigning the at least one of the collaboration requests and collaboration responses to the corresponding engineering data object of the at least one of the source engineering tool and the at least one target engineering tool so that an owner and receiver of the respective engineering data objects are automatically notified of data processing and corresponding collaboration requests or responses across the source engineering tool and the at least one target engineering tool and corresponding source and target data processing units, respectively.

### BRIEF DESCRIPTION OF THE DRAWINGS

Additional refinements, advantages and features of the present disclosure are described in more detail below with reference to exemplary embodiments illustrated in the drawings, in which:

FIG. 1 illustrates a known technique of independent engineering tools with individual data bases and separate data exchange relations;

FIG. 2 illustrates a known data exchange by means of a file;

FIG. 3 illustrates an example of a collaboration system for independent engineering tools with each an individual data storage system, according to an exemplary embodiment of the present disclosure; and

FIG. 4 illustrates an example of a collaboration system for engineering tools with a central and common data storage system, according to an exemplary embodiment of the present disclosure.

### DETAILED DESCRIPTION

Exemplary embodiments of the present disclosure provide a system and method which accomplish an improved collaboration, messaging and exchange of information between engineering tools and engineers. Exemplary embodiments of the present disclosure overcome the above mentioned drawbacks with known techniques and provide a simplified and systematic collaboration system and method.

An exemplary embodiment of the present disclosure provides a system for a guided and smart collaboration, for automation engineering in the area of, for example, manufacturing, power, chemical and/or process industry. In contrast to known techniques, the collaboration system and method of the present disclosure includes a messaging system that provides collaboration functionality that is bound to the engineering objects and not to the engineers. Therefore, the collaboration becomes more independent from the individual network of human beings but becomes an integral part of a guided collaboration system.

An exemplary embodiment of the present disclosure includes an electronic data processing unit which is combined with or includes a source engineering tool with an engineering data storage that is provided to exchange data with a target engineering tool with another engineering data storage, wherein the creator of an engineering object in the source engineering tool is called “owner” who provides the engineering data to the target engineering tool whose owner is called “receiver”. In accordance with an exemplary embodiment of the present disclosure, the owner of the engineering object is known to the object itself. The owner can be a specific person, or a role that can be fulfilled by different persons, for example.

The system and method according to the present disclosure provide means to enter mentioned “collaboration requests” as questions, messages, hints, requests, complaints etc. and to automatically send it to the subject of the collaboration—the engineering object itself—instead of sending it directly to the owner. Hence, in accordance with the present disclosure, it is no longer necessary to identify the owner of the object or to have a relation to that person. Instead, the collaboration request becomes part of the object and is accessible by all persons dealing with that object. Thus, the collaboration content is bound to the object. It does not have to be sent directly to the owner or is sent and afterwards hidden in the owner's personal mail box.

Consequently, an exemplary embodiment of the present disclosure provides that any owner or receiver of the related engineering object automatically receives information about corresponding collaboration requests or responses, for example, passively by separate message lists, or subtle by means of graphical or textual hints within their engineering tool, or actively by means of automatically generated telephone calls or automatically sent e-mails respectively short-messages, when any occurrence has happened and any action seems to be necessary. Consequently, the result of these features of the present disclosure is a rather simplified way of collaboration.

In accordance with an exemplary embodiment of the present disclosure, any owner who has access to this object can respond to the collaboration request, whereas as a result all collaboration requests and responses become part of the object.

In accordance with an exemplary embodiment of the system according the present disclosure, the reading of already posted collaboration requests and responses is enabled, and thus there is an avoidance of double questioning and assistance with identifying typical issues related to specific engineering objects.

In accordance with an exemplary embodiment of the system according to the present disclosure. the history of collaboration requests or responses or at least part of it is stored so that it allows for the re-use in other projects or provides for transfer of this collaboration information to libraries for re-use at a later date.

In accordance with an exemplary embodiment, the system includes means for classification of collaboration requests, e.g. as “Question”, “Request for Update”, “Remark”, “Hint”, “Complaint”, whereas the system provides for means which indicate the status of the respective collaboration request according to the actual situation, e.g. “accepted”, “rejected” or “closed” or “done”.

An exemplary embodiment of the system according to the present disclosure provides that only the owner and/or the sender are allowed to change the status of the collaboration request.

An exemplary embodiment of the present disclosure provides that any collaboration requests and/or responses contain definite information about documents, links to documents, figures, data models or other engineering information of any kind.

Accordingly, the collaboration content and its history are provided to the users in a structured and searchable way to enable the engineer, who is confronted with a new question corresponding to a certain engineering object, to inform himself by reading the collaboration history before he enters a new collaboration request.

In accordance with an exemplary embodiment of the present disclosure, the collaboration system provides statistical functionality which provides information as, for example, a “number of open topics”, “relation of open and closed topics”, as well as lists of topics sorted against its priority or delay whereas the owners are enabled by the statistical functionality of the system to identify relevant topics in order to stimulate the collaboration between the engineers.

In accordance with an exemplary embodiment of the present disclosure the collaboration system stores the collaboration history directly in the database of the owners' engineering tool, respectively. According to an exemplary embodiment, the system stores the collaboration history separately from the engineering tools or the system shifts the collaboration functionality into a separate data exchange framework. This allows for the engineering tools to be kept independent from each other and to introduce the collaboration system without changing the engineering tools.

In accordance with an exemplary embodiment, the system provides for the owner or the role of an object to be dynamically assigned over the engineering lifecycle, for example, in case of a change of the owner or the role of an object, and the engineering object's lifecycle status is assigned to the engineering object. Examples are “basic planning finished”, “detail planning finished”, “in operation since . . . ”, “repaired at”. This additionally simplifies the collaboration process and extends its usability in the operation and maintenance phase of a manufacturing or process plant.

In accordance with an exemplary embodiment of the present disclosure, the collaboration system provides for the dedicated engineering information to be entered into a collaboration request, and represents interpretable or executable information from the source engineering tool to the target engineering tool, whereas once accepted by the engineer, this data is automatically imported into the target engineering tool, where it is proven and executed in order to fulfill the request. An example is the re-quest “Rename all signals <Rob00*_Begin> to <Rob00*_Start>” which is sent from the second to the first engineering tool. This request can be automatically executed by the first engineering tool after approval from the owner of these data. Alternatively, the owner can reject this request or can request further information from the receiver.

An exemplary embodiment of the present disclosure also provides a method for the collaboration between engineering tools and engineers using data processing units which are combined with or include a source engineering tool with a source engineering data storage provided for the exchange of data with at least one target data processing unit including at least one target engineering tool with its own engineering data storage. The exemplary collaboration method provides for the generation of collaboration requests or collaboration responses which are automatically assigned to the corresponding engineering data object, whereas the owner and receivers of the respective engineering data objects automatically are notified as to corresponding collaboration requests or responses across engineering tools and data processing.

The exemplary method provides all the steps which are provided by the claimed system according to the present disclosure. Hence these features which have been explicitly illustrated with the description of the claimed system are also applicable with the exemplary method according to the present disclosure. Accordingly, the method of the present disclosure includes providing a response to the collaboration request by at least one of the receivers and/or owners which have access to the respective object, where, as a result, all collaboration requests and responses are collected as a part of the object in order provide for reading of already posted collaboration requests and responses and for identification of typical issues related to different engineering objects. In addition, the history of collaboration requests or responses or part of it is stored for reuse in other projects, and/or the collaboration information is transferred to libraries for later re-use.

According to an exemplary embodiment of the method of the present disclosure, the collaboration requests can be classified, e.g. as “Question”, “Request for Update”, “Remark”, “Hint”, “Complaint”, can be associated with properties like “Priority” or “Due Date”, as well as the status of a collaboration request can be changed, e.g. “accepted”, “rejected” or “closed” or “done” whereas the status of the collaboration request only can be changed by its owner and/or the sender.

Likewise, the method provides that dedicated engineering information is included into a collaboration request, whereas an interpretable or executable information is rewarded from the target engineering tool to the source engineering tool. This data is automatically imported into the source engineering tool, proven and executed in order to fulfil the request once it is accepted by the owner.

According to an exemplary embodiment of the method of the present disclosure, any change of an owner or a role of an object or any change of the engineering process, for example, the change of an engineer's responsibility or position, is assigned to the data object dynamically over the engineering lifecycle.

In accordance with an exemplary embodiment of the method of the present disclosure, the engineering object's lifecycle status is assigned to the engineering object, whereas the collaboration process is simplified and additionally its usability in the operation and maintenance phase of a manufacturing or process plant is extended.

In accordance with an exemplary embodiment, the method of the present disclosure is provided for collaboration, messaging and information exchange between engineering tools and engineers, whereas any owner or receivers of the related engineering object will be automatically informed about corresponding collaboration requests or answers by means of automatically dialed telephone calls or automatically sent e-mails or short-messages.

FIG. 1 illustrates a known combination of a common database and a private database which has already been described already in the introductory part of this specification.

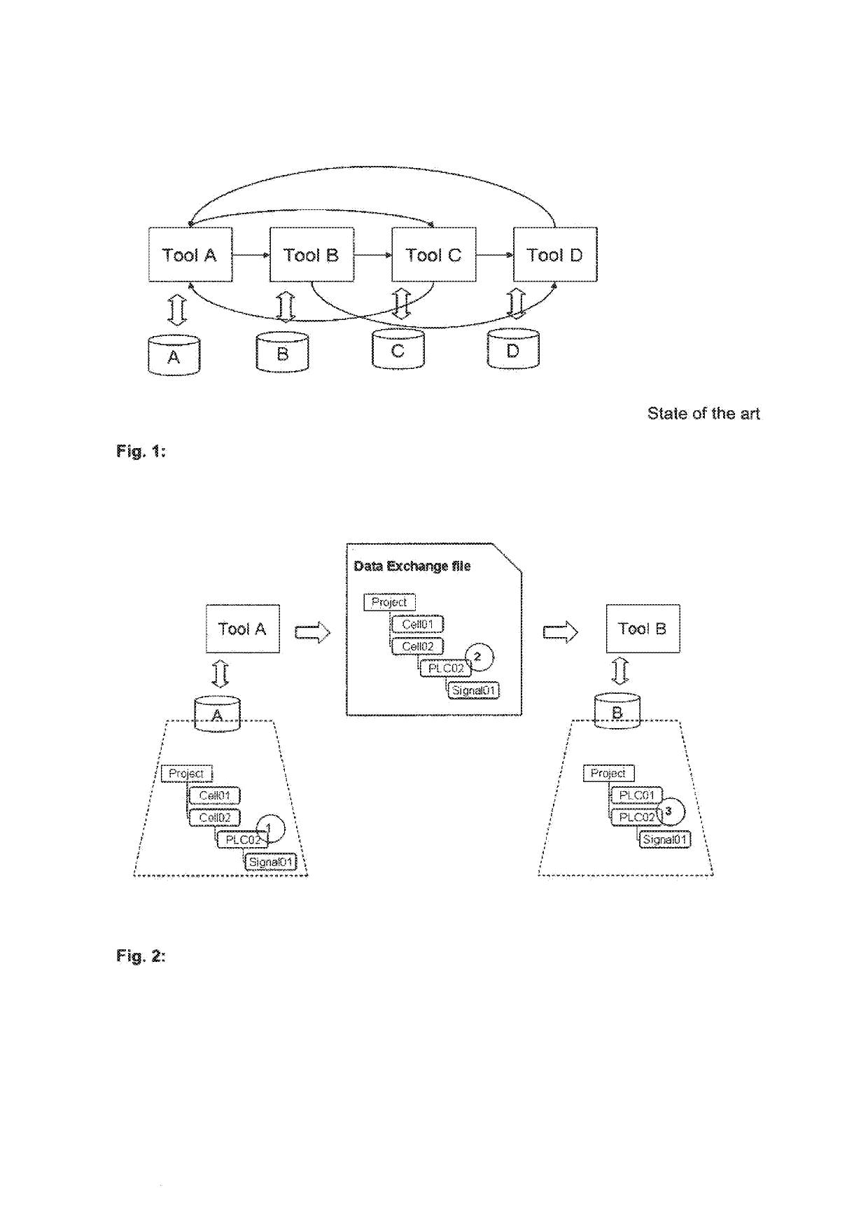

FIG. 2 illustrates another known data exchange system which has already been described in the introductory part of this specification.

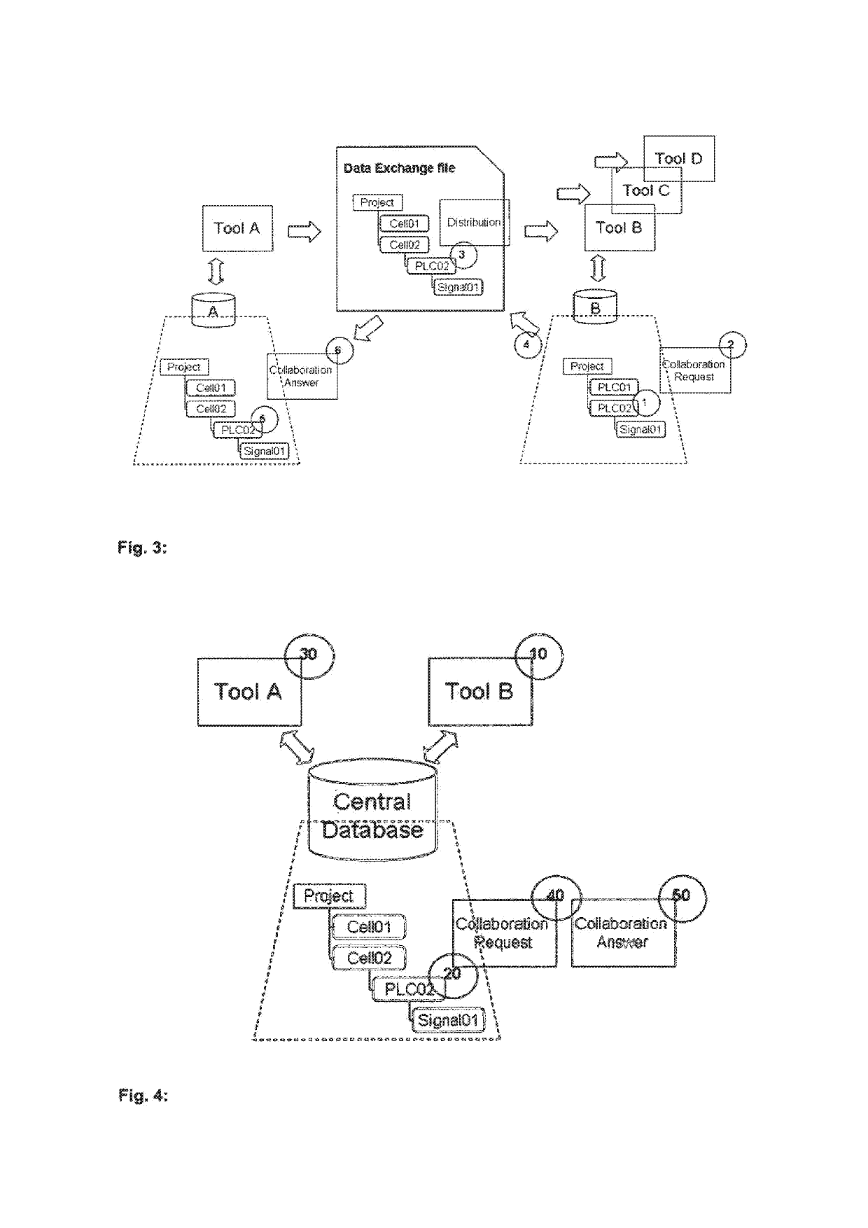

FIG. 3 illustrates an exemplary embodiment of a collaboration system according to the present disclosure which is designed for independent engineering tools that require a separate data exchange process.

It is assumed, for example, that the engineer of “Tool B” has a collaboration request 4 related to the object “PLC02” 2, such as a question of “Please provide the change document of the current PLC firmware release”. The collaboration system of the present disclosure provides an input system 4 (e.g. a form or other electronic input means) to the engineer for allowing entry of this request into the system. Accordingly, this request will be related to the “Tool B”.

The collaboration system automatically feeds 4 the collaboration request 2 back to its representation in the data exchange file or a suited proxy of it. From here, the collaboration request is automatically distributed to Tool A and the origin of the PLC object 5. According to an exemplary embodiment of the present disclosure, the owner of “Tool A” and the object “PLC02” 5 is informed and can answer this request by means of the input system 6. For example, the collaboration response may contain the requested document or a link to it. This answer is fed back to the object 3 afterwards and hence it is available to all other tools, for example, Tool C, Tool D, which have access to the object 3. Finally, the engineer of “Tool B” will get an answer to his request.

An advantage of this automatic collaboration system and method is that the collaboration content is associated with the respective object, and it is provided to both the owner and other receivers, for example, Tool C and D. Hence, all receivers and owners which have access to the object can inform themselves and can read the collaboration requests related to this object.

FIG. 4 illustrates an exemplary embodiment of the collaboration system according to the present disclosure which is designed for engineering tools that have a shared and common data model and data storage system.

It is assumed, for example, that an engineer utilizing “Tool B” 10 creates a collaboration request related to the object “PLC02” 20. According to an exemplary embodiment of the present disclosure, the collaboration system provides an input system 40 (e.g. a form or other electronic input means) to the engineer of “Tool B” 10 and allows the request that is related to the object 20 to be entered.

The engineer of “Tool A” 30 is automatically informed about the new collaboration request and can take notice of it. The collaboration system provides another input system 50 that allows entering a collaboration response. This answer is afterwards available to all tools that have access to the object 20, so for “Tool B” 10 and its engineer.

In accordance with an exemplary embodiment, the data processing units of the respective source and target tools can be implemented by means of a processor of a respective computer processing device (e.g., a CPU) executing a software program tangibly recorded on a non-transitory computer-readable recording medium (e.g., a non-volatile memory). By executing the computer program, the respective data processing unit is configured to execute the operative features as described herein.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### REFERENCE LIST

### Referring to FIG. 3

1 object “PLC02” within the da-tabase of Tool B
2 collaboration request
3 distribution
4 information flow from Tool B to the data exchange file
5 object “PLC02” within the da-tabase of Tool A
6 collaboration response

Referring to FIG. 4
10 Tool B
20 object “PLC02” in the central data base of Tool A and Tool B
30 Tool A
40 collaboration request
50 collaboration response

What is claimed is:

1. A system for collaboration between engineering tools and engineers, the system comprising:
a source data processing unit associated with a source engineering tool having a source engineering data storage that stores an engineering data object about the source engineering tool; and
at least one target data processing unit respectively associated with at least one target engineering tool having a source engineering data storage that stores an engineering data object about the at least one target engineering tool, respectively,
wherein the source data processing unit is configured to exchange data with the at least one target data processing unit to enable engineers of the source or target engineering tools to create collaboration requests or collaboration responses which are automatically assigned to the corresponding engineering data object of the source or target engineering tools, and to automatically notify an owner and receiver of respective engineering data objects of corresponding collaboration requests or responses across the source engineering tool and the at least one target engineering tool and corresponding source and target data processing units, respectively.

2. The system according to claim 1, wherein the owner and receiver are automatically notified about the existence of new collaboration requests or responses by means of at least one of lists, graphical hints, textual hints, automatically generated telephone calls, automatically sent e-mails, and automatically sent short-messages.

3. The system according to claim 1, wherein the data exchange between the source data processing unit and the at least one target data processing unit provides access to already posted collaboration content of data objects to avoid double questioning and to assist in identifying issues related to specific engineering objects.

4. The system according to claim 1, wherein the data exchange between the source data processing unit and the at least one target data processing unit provides collaboration content and a collaboration history in a structured and searchable format to enable the engineer, when confronted with a new question corresponding to a certain engineering object, to review the collaboration history before entering a new collaboration request.

5. The system according to claim 4, wherein the collaboration history includes a stored record of at least one of collaboration requests and responses to the collaboration requests to allow for at least one of reuse in other projects and transfer of collaboration information to libraries for reuse at a later date.

6. The system according to claim 1, comprising:
means for classification of collaboration requests; and
means for assigning properties to the collaboration requests.

7. The system according to claim 1, comprising:
means for indicating a status of a collaboration request according to an actual situation.

8. The system according to claim 5, wherein only the owner and/or a sender are permitted to change an engineering life cycle status of a collaboration request.

9. The system according to claim 5, wherein at least one of the collaboration requests and responses to the collaboration requests include definite information including at least one of text, graphics, documents, links to documents, links to figures, links to data models, and links to engineering information.

10. The system according to claim 5, wherein at least one of the collaboration requests and responses to the collaboration requests contain at least one of executable data and automatically interpretable data.

11. The system according to claim 1, comprising:
means for providing statistical functionality including information about at least one of a number of open topics, a relation of open and closed topics, and a list of topics sorted against a priority or delay.

12. The system according to claim 11, wherein the owners are enabled by the statistical functionality of the system to identify relevant topics to stimulate collaboration between the engineers.

13. The system according to claim 4, wherein the collaboration history is stored directly in the corresponding database of the owners' engineering tool.

14. The system according to claim 4, wherein the collaboration history is stored separately from the engineering tools.

15. The system according to claim 1, wherein a collaboration functionality is integrated into at least one of the engineering tools.

16. The system according to claim 15, wherein the collaboration functionality is provided by a separate system independent from the engineering tools.

17. The system according to claim 1, wherein in case of a change of the owner or a role of an object, the system comprises means for dynamically assigning the change over an engineering lifecycle to the respective owner or the role of an object.

18. The system according to claim 1, comprising:
means for assigning an engineering object's lifecycle status to a corresponding engineering object.

19. A method for collaboration between engineering tools and engineers, the method comprising:
providing at least one first engineer with a source data processing unit associated with a source engineering tool having a source engineering data storage that stores an engineering data object about the source engineering tool;
providing at least one second engineer with at least one target data processing unit respectively associated with at least one target engineering tool having a source engineering data storage that stores an engineering data object about the at least one target engineering tool, respectively;
generating, in at least one of the source data processing unit and the at least one target data processing unit, at least one of collaboration requests and responses to the collaboration requests for at least one of the source engineering tool and the at least one target engineering tool; and
automatically assigning the at least one of the collaboration requests and collaboration responses to the corresponding engineering data object of the at least one of the source engineering tool and the at least one target engineering tool so that an owner and receiver of the respective engineering data objects are automatically notified of data processing and corresponding collaboration requests or responses across the source engineering tool and the at least one target engineering tool and corresponding source and target data processing units, respectively.

20. The method according to claim 19, comprising:
providing a response to a collaboration request by at least one of the receiver and owner who has access to the respective object so that all collaboration requests and responses are collected as a part of the object to provide a history of already posted collaboration requests or responses and an identification of issues related to engineering objects.

21. The method according to claim 20, wherein the history of collaboration requests or responses is at least one of stored for reuse in other projects and transferred to libraries for later reuse.

22. The method according to claim 19, comprising:
classifying the collaboration requests;
associating the collaboration requests with a property; and
updating a status of the collaboration requests.

23. The method according to claim 19, wherein dedicated engineering information is included into a collaboration request, and wherein the method comprises:
providing interpretable or executable information from the target engineering tool to the source engineering tool; and
automatically importing the interpretable or executable information into the source engineering tool to fulfil the collaboration request once it is accepted by an owner. of the source engineering tool.

24. The method according to claim 19, comprising:
assigning at least one of a change of an owner, a change of a role of an object, and a change of an engineering process to the data object associated with the at least one of changed owner, role and engineering process dynamically over an engineering lifecycle of the corresponding engineering tool.

25. The method according to claim 19, wherein an engineering object's lifecycle status is assigned to an engineering object to simplify the collaboration process and extend usability of the engineering object in at least one of an operation and maintenance phase of a manufacturing or process plant.

26. The system according to claim 6, wherein the classification includes at least one of a “Question”, “Request for Update”, “Remark”, “Hint”, “Complaint”, and
wherein the properties assigned to the collaboration requests include at least one of “Priority” and “Due Date”.

27. The system according to claim 7, wherein the indicated status of a collaboration request includes at least one of “accepted”, “rejected”, “closed” and “done”.

28. The method according to claim 22, wherein:
the collaboration requests are classified according to at least one of a “Question”, “Re-quest for Update”, “Remark”, “Hint” and “Complaint”;
the property associated with the collaboration requests include at least one of “Priority” and “Due Date”; and
the status of the collaboration request includes at least one of “accepted”, “rejected”, “closed” and “done”, and the status of the collaboration requests is changeable only by an owner or sender of the corresponding collaboration request.
